(19) United States
(12) Patent Application Publication
(10) Pub. No.: US 2014/0023212 A1
(43) Pub. Date: Jan. 23, 2014

(54) Wireless Hearing Aid System

(71) Applicant: Bret Herscher, Cupertino, CA (US)

(72) Inventor: Bret Herscher, Cupertino, CA (US)

(21) Appl. No.: 13/942,908

(22) Filed: Jul. 16, 2013

Related U.S. Application Data
(60) Provisional application No. 61/741,369, filed on Jul. 18, 2012.
(60) Provisional application No. 61/705,226, filed on Sep. 25, 2012.

(51) Int. Cl. H04R 25/00

(52) U.S. Cl. CPC H04R 25/407
USPC 381/313

(57) ABSTRACT

A hearing aid system comprising first and second ear units or hearing aids, and an external audio signal receiver, the first and second ear units including an audio sensor and transceiver, the audio sensor being configured to detect audio signals emanating from the environment, the transceiver being configured to transmit directionality signals representing amplitude and phase of detected audio signals to said acoustic signal receiver, the audio signal receiver including processing means for processing the audio and directionality signals and generating reconstructed acoustic signals that include direction parameters representing a direction of origin of at least one audio signal, the audio signal receiver further including wireless signal transmission means for transmitting the reconstructed acoustic signals to the ear units.

### CROSS-REFERENCE TO RELATED APPLICATIONS

This application claims the priority of U.S. Provisional Application Nos. 61/741,369, filed Jul. 18, 2012, and 61/705,226, filed Sep. 25, 2012.

### FIELD OF THE INVENTION

The present invention relates to hearing systems. More particularly, the present invention relates to wireless hearing aid systems having enhanced audio quality and perception of direction of origin of audio signals, and methods for providing same.

### BACKGROUND OF THE INVENTION

The development of hearing aids has, in many instances, been miss-directed to less important aspects of hearing aid design; in particular, hearing aid size, appearance and placement. These factors may well seem important to newly diagnosed sufferers of hearing loss, but are of considerably less importance to long term sufferers who would prefer improved comfort and performance.

Behind-the-ear (BTE) and in-ear (IN) hearing aids help to disguise the user's hearing disability. However, in such devices, the microphone is typically concealed. This often results in poor directionality, which, in turn, results in a poor signal-to-noise ratio. The directionality of such devices is also adversely affected by the position of a user's head relative to a sound source. Indeed, as is well known in the art, a major problem associated with conventional hearing aids is “head shadowing”, i.e. a condition that occurs when the head is disposed between the hearing aid and the sound source, thereby rendering many sound sources inaudible.

In difficult listening conditions, such as a crowded room, the hard of hearing will also often turn their head so that the better ear faces the sound source, e.g., speaker, whereby the signal-to-noise ratio is improved. However, in doing so the hearing aid is then pointing away from the sound source, i.e. in the wrong direction. This situation highlights another major problem associated with conventional hearing aids—most conventional hearing aids can, at best, only enhance sounds coming from the direction in which the user is facing.

A further problem associated with conventional hearing aids is that they are often devoid of any discreet and easy means for adjusting the functionality of the hearing aid. Indeed, in most conventional behind-the-ear and in-ear hearing aids the controls, e.g. volume, are often minute and relatively inaccessible when the hearing aid is in use. Adjusting the miniaturized controls is also particularly difficult for the aged, disabled and those suffering from various arthritic conditions.

Finally, development efforts directed to reducing hearing aid size have typically resulted in hearing aid designs with the microphone placed so close to the loudspeaker (or transmitter) in the ear-piece, that the volume threshold is considerably lower. As a result, to avoid whistling feed-back, the user must either avoid loud sound sources or set the volume control at a low level.

It would thus be desirable to provide a hearing aid and associated system that overcome the noted drawbacks and disadvantages associated with conventional hearing aids.

It is thus an object of the invention to provide hearing aid systems that overcome many of the drawbacks and disadvantages associated with conventional hearing aids.

It is another object of the invention to provide multi-unit hearing aid systems having enhanced audio quality and perception of direction of origin of audio signals.

It is another object of the invention to provide multi-unit hearing aid systems that include ear units having minimal power requirements.

### SUMMARY OF THE INVENTION

The present invention is directed to multi-unit hearing aid systems that provide enhanced sound quality and directionality. In one embodiment, the hearing aid system includes at least one remote or external audio signal receiver and at least one ear unit, i.e. a hearing component or sub-system disposed proximate to or within the ear of a subject.

In a preferred embodiment of the invention, the external audio signal receiver includes at least one means for receiving audio input signals from a sound or audio source.

In some embodiments, the means for receiving audio input signals comprises at least one microphone. In some embodiments of the invention, the external audio signal receiver includes a plurality of microphones.

In some embodiments of the invention, the external audio signal receiver also includes processing means, e.g. a microprocessor or DSP, which is programmed to process received audio input signals from an external sound or audio source (or multiple audio sources) and/or directionality signals from an ear unit, and generate one or more reconstructed acoustic signals from the audio and/or directionality signals. According to the invention, the reconstructed acoustic signals can comprise, without limitation, spectrally optimized signals, amplified audio signals, and enhanced audio signals, e.g. optimal signal-to-noise ratio. In at least one embodiment of the invention, the reconstructed acoustic signals include direction (or directionality) parameters representing the direction of origin of the audio signals.

In a preferred embodiment, the external audio signal receiver also includes means for wirelessly transmitting reconstructed acoustic signals to an ear unit (or multiple ear units, if employed).

In a preferred embodiment, the ear unit includes means for wirelessly receiving the reconstructed acoustic signals from the external audio signal receiver and means for transmitting reconstructed acoustic signals to a subject. In some embodiments, the ear unit also includes means for transmitting signals, e.g., directionality signals, to the signal receiver.

A significant feature and, hence, advantage of the hearing aid systems of the invention is the ability of the systems to receive external audio signals and generate reconstructed acoustic signals from the audio and/or directionality signals, which, when transmitted to a subject, allow him/her to perceive the direction of origin of the external audio signals and/or spatial orientation of the audio signals.

Another significant advantage of the hearing aid systems of the invention is that by disposing most of the electronic components, e.g. microphone, microprocessor, wireless transmitter, etc., in the external audio signal receiver, the power consumption of the ear unit(s) is exceedingly small. Thus, smaller power sources can be disposed in the ear unit(s) and/or the ear unit(s) can comprise a disposable device.

A further advantage of the hearing aid systems of the invention is by having one or more “external” microphones the feed-back problems that are associated with many conventional hearing aids, wherein the microphone and transmitter are in close proximity, are eliminated.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a schematic illustration of one embodiment of a hearing aid system, in accordance with the invention;

FIG. 2 is a schematic illustration of another embodiment of a hearing aid system, in accordance with the invention; and

FIG. 3 is a schematic illustration of another embodiment of an acoustic signal receiver, in accordance with the invention.

### DETAILED DESCRIPTION OF THE PREFERRED EMBODIMENT

Before describing the present invention in detail, it is to be understood that this invention is not limited to particularly exemplified apparatus, systems, structures or methods as such may, of course, vary. Thus, although a number of apparatus, systems and methods similar or equivalent to those described herein can be used in the practice of the present invention, the preferred apparatus, systems, structures and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise. Thus, for example, reference to “an acoustic signal” includes two or more such signals and the like.

### DEFINITIONS

The terms “hearing aid” and “hearing prosthesis” are used interchangeably herein and mean and include any device or system that is adapted to amplify and/or modulate and/or improve and/or augment sound or acoustic signals transmitted to (or for) a subject.

The term “processing means”, as used herein, means and includes any analog or digital device, system or component that is programmed and/or configured to process signals, including, without limitation, a microprocessor and DSP.

The term “spectrally optimized signal”, as used herein, means and includes a signal that has been adjusted or customized, i.e. tuned, for a specific subject.

The following disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

As will readily be appreciated by one having ordinary skill in the art, the present invention substantially reduces or eliminates the disadvantages and drawbacks associated with conventional hearing aids or prosthesis.

Generally, the hearing aid systems of the invention comprise linked multi-unit systems that provide enhanced sound quality and, in some embodiments, enhanced directionality.

In a preferred embodiment of the invention, the hearing aid system includes at least one remote or external audio signal receiver and at least one ear unit. The external audio receiver includes means for receiving audio or acoustic (i.e. input) signals from at least one source, means for generating at least one reconstructed acoustic signal from the received audio input signals and, in some embodiments, directionality signals, and means for transmitting at least one reconstructed acoustic signal to the ear unit(s). According to the invention, the audio input signals can comprise digital and/or analog signals.

In some embodiments of the invention, the means for receiving audio input signals comprises at least one microphone. In some embodiments, the external audio signal receiver includes or is in communication with a plurality of microphones.

In some embodiments, the microphones comprise directional microphones. According to the invention, the directional microphone(s) can comprise any form, e.g. omni-directional, multi-directional, preferred audio source amplification, noise cancellation, etc.

In some embodiments of the invention, the external audio signal receiver also includes processing means, e.g. a microprocessor or DSP, which is programmed to process received audio input signals from an external sound or audio source (or multiple audio sources) and/or directionality signals from an ear unit, and generate one or more reconstructed acoustic signals from the audio and/or directionality signals. According to the invention, the reconstructed acoustic signals can comprise, without limitation, spectrally optimized signals, amplified audio signals, and enhanced audio signals, e.g. optimal signal-to-noise ratio.

In at least one embodiment of the invention, the reconstructed acoustic signals include direction (or directionality) parameters representing the direction of origin of the audio signals.

In some embodiments of the invention, the processing means is further programmed to differentiate, and balance and/or prioritize and/or enhance multiple signals contained in a single medium. By way of example, if the audio input signals comprise music from one sound source and a conversation between two persons, the processing means can be programmed and configured to accord a higher priority to the signals representing the conversation and enhance those signals and/or minimize the signals representing the music.

According to the invention, various conventional means can be employed to differentiate the audio signals, including, without limitation, digital encoding, time division multiplex, frequency division multiplex, code division multiplex access, etc.

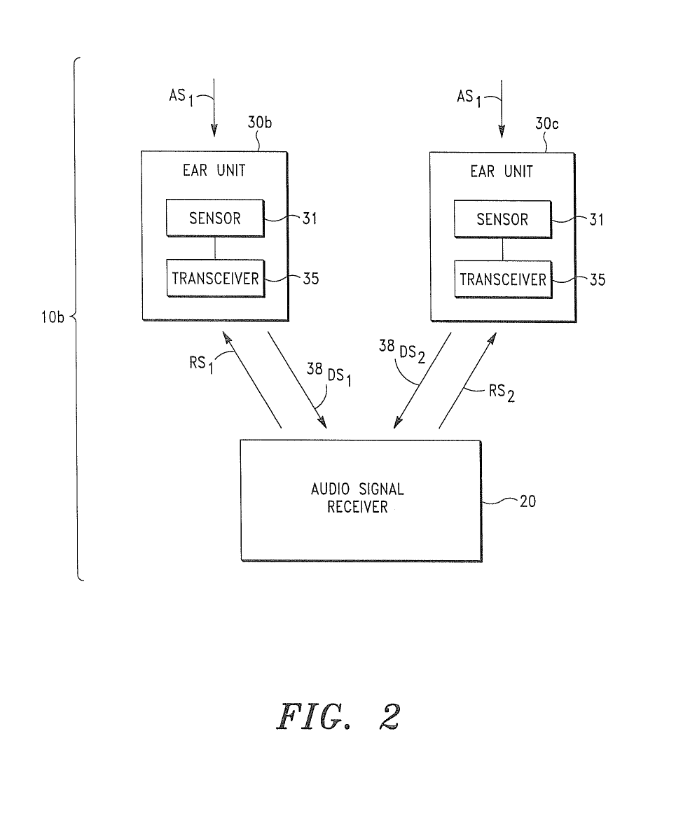

In embodiments of the invention, wherein two ear units are employed (see, e.g. FIG. 2), the differentiated signals can be transmitted to one ear unit (or ear) with minimal, if any, interference or both ear units.

According to the invention, the external audio signal receiver can also include various additional electronic components and systems, including, without limitation, memory and display means.

In a preferred embodiment of the invention, the external audio signal receiver also includes means for transmitting reconstructed acoustic signals to an ear unit (or ear units). In a preferred embodiment, the external audio signal receiver includes wireless transmission means for transmitting reconstructed acoustic signals to an ear unit (or ear units). According to the invention, the wireless transmission means can comprise any conventional wireless means, including, without limitation, radio frequency, light and sound.

According to the invention, the “radio frequency” variants can include, without limitation, Bluetooth, Zigbee, 802.11, 802.15.4, as well as custom protocols.

According to the invention, the “light” variants can include, without limitation, infrared, visible, laser, etc.

According to the invention, the “sound” variants can include, without limitation, ultrasound, audible sound, audio signals below 20 Hz, etc.

In a preferred embodiment of the invention, the external audio signal receiver further includes at least one power source. According to the invention, the power source can comprise various conventional power sources, including, without limitation, chargeable and non-chargeable batteries, and/or an energy harvesting system.

According to the invention, the external audio signal receiver can be disposed inside or outside of the ear canal. The components or sub-systems of the external audio signal receiver can also be disposed within and/or outside of the ear canal.

In a preferred embodiment, the external audio signal receiver and all components and subsystems associated therewith are disposed outside the ear canal and, hence, a first distance from an ear unit (or ear units).

According to the invention, the external audio signal receiver can thus be disposed in or comprise an external button or pendant that can be readily attached to clothing or worn as a necklace.

According to the invention, the ear unit(s) can comprise either a behind-the-ear or in-ear canal device. In a preferred embodiment of the invention, the ear units include means for wirelessly receiving the reconstructed acoustic signals from the external audio signal receiver. According to the invention, such means can include, without limitation, a wireless receiver and one or more sensors.

The ear units can also optionally include one or more microphones. According to the invention, the microphones can also comprise receivers or can comprise receivers and sensors, whereby the microphones can receive the acoustic signals from the external audio signal receiver as well as separate audio signals from the environment. As discussed in detail below, the microphones can also comprise directional microphones.

The ear units also preferably include means for transmitting reconstructed acoustic signals to a subject. According to the invention, such means can include, without limitation, apparatus and/or systems that are configured to transmit acoustic signals via air conduction, apparatus and/or systems that are configured to transmit acoustic signals via bone conduction, and apparatus and/or systems that are configured to transmit acoustic signals via the body, e.g. skin.

In some embodiments of the invention, the ear unit further includes signal transmitting means for transmitting signals, e.g., directionality signals, to the external audio signal receiver.

In some embodiments (discussed below), the ear units further include processing means for processing audio signals and/or controlling transmission of reconstructed acoustic signals to a subject.

A significant advantage of the hearing aid systems of the invention is that by placing most of the electronic components, e.g. microphone, microprocessor or DSP, wireless transmitter, etc., in the external audio signal receiver, the power consumption of the ear unit is exceedingly small. Thus, smaller power sources can be disposed in the ear unit, which can, in most instances reduce the size of the ear unit, and/or the ear unit can comprise a disposable device.

Further, the hearing aid systems of the invention are not restricted by power requirements.

Another significant advantage of the hearing aid systems of the invention is by having one or more “external” microphones the feedback problems that are associated with many conventional hearing aids, wherein the microphone and transmitter are in close proximity, are eliminated.

As stated above, another significant feature and, hence, advantage of the hearing aid systems of the invention is the ability of the systems to receive external audio signals and generate reconstructed acoustic signals therefrom, which, when transmitted to a subject, allow him/her to readily perceive the direction of origin of the external audio signals and/or spatial orientation components of the audio signals.

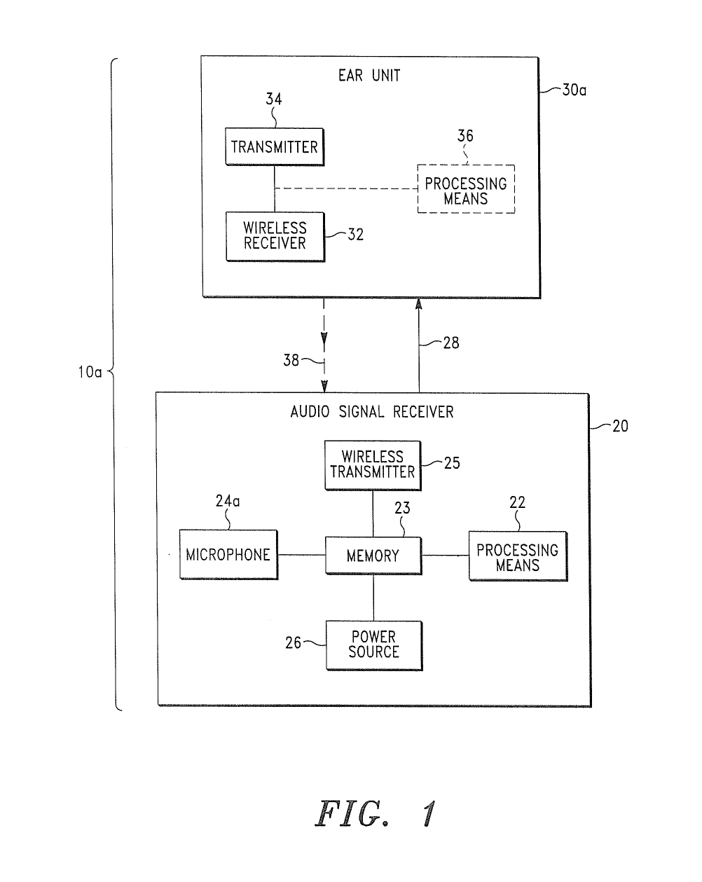

Referring now to FIG. 1, there is shown one embodiment of a hearing aid system of the invention. As illustrated in FIG. 1, the hearing aid system 10a includes an ear unit 30a and an “external” audio signal receiver 20.

In a preferred embodiment, ear unit 30a includes a predetermined custom acoustic signal profile.

In some embodiments of the invention, the ear unit 30a includes at least one wireless receiver 32 that is adapted to receive reconstructed acoustic signals 28 from the audio signal receiver 20, and a transmitter 34 that is adapted to transmit acoustic signals to the inner ear of a subject, whereby the subject is able to hear the sound(s) emanating from the environment, e.g. a conversation between two people, and, in some embodiments, discern the direction of origin of the sound(s).

In some embodiments, the ear unit 30a alternatively includes a transceiver that is adapted to receive reconstructed acoustic signals 28 from the audio signal receiver 20 and transmit the acoustic signals to the inner ear of a subject.

In some embodiments of the invention, the ear unit 30a includes an audio sensor that is configured to detect and receive audio signals emanating from the environment.

In some embodiments of the invention, the ear unit 30a (and 30b and 30c, discussed below) also includes processing means 36, e.g. microprocessor or DSP, which is programmed to process audio signals and/or control the transmission of acoustic signals to the subject.

In some embodiments, the ear unit 30a (and 30b and 30c, discussed below) also includes means for wirelessly transmitting signals 38, e.g., directionality signals, back to the audio signal receiver 20. In some embodiments, the ear unit means for transmitting signals to the signal receiver comprises a second transmitter.

As further illustrated in FIG. 1, in some embodiments, the audio signal receiver 20 includes a first microphone 24a, processing means 22, e.g. a microprocessor or DSP, a memory module 23, wireless transmitter 25 and power source 26.

The first microphone 24a is adapted to receive audio input signals from an external audio source, e.g., speech of a second party, and, in some embodiments, detect the direction of origin of the audio input signals. The first microphone 24a is further adapted to transmit (or communicate) the input signals to the processing means 22.

In some embodiments of the invention, the first microphone 24a comprises a directional microphone. In the noted embodiments, the receiver 20 and, hence, microphone 24a can be directed forward of the audio signal receiver 20 or from the subject or user or from the user's face. The user can then benefit from the directionality of the microphone 24a by pointing the audio signal receiver 20 and, hence, directional microphone 24a in the direction(s) that the user desires to focus on.

The processing means 22 is preferably programmed to process the audio input signals and generate reconstructed acoustic signals from the audio input signals. As indicated above, the reconstructed acoustic signals can comprise spectrally optimized signals, amplified audio signals and enhanced audio signals, e.g. optimal signal-to-noise ratio.

In a preferred embodiment of the invention, the reconstructed acoustic signals include direction parameters representing the direction of origin of the audio input signals. Referring now to FIG. 2, in these embodiments, the hearing aid system (denoted “10b”) includes an external signal receiver 20 and two (2) ear units 30b, 30c.

In a preferred embodiment, each ear unit 30b, 30c includes an audio sensor 31 and an asymmetric transceiver 35; the sensor 31 being configured to detect and receive audio input signals (denoted “AS₁”), and the amplitude and phase thereof, the transceiver 35 being configured to (i) transmit directionality signals (denoted “38_{DS1} and 38_{DS2}”) to the external receiver 20 and (ii) receive reconstructed acoustic signals (denoted “RS₁ and RS₂”). Each ear unit 30b, 30c also preferably includes a predetermined custom acoustic signal profile for each ear associated therewith.

In a preferred embodiment, the directionality signals 38_{DS1}, 38_{DS2} comprise small binary signals. Preferably, the transceiver 35 is configured to wirelessly transmit directionality signals 38_{DS1}, 38_{DS2} to the external receiver 20.

In these embodiments, the processing means 22 of external receiver 20 is further programmed to process the directionality signals 38_{DS1}, 38_{DS2} that are transmitted by the ear units 30b, 30c and the audio signal AS₁ received by microphone 24a, and generate reconstructed acoustic signals RS₁, RS₂ that include direction parameters.

According to one embodiment of the invention, the direction parameters are derived as follows: When an audio signal AS₁ emanates from an external source, the external audio signal receiver 20 detects and records the audio signal AS₁ (hereinafter “original audio signal”). Each ear unit 30b, 30c also detects the amplitude and phase of the original audio signal AS₁ and wirelessly transmits a directionality signal 38_{DS1}, 38_{DS2}, representing the amplitude and phase detected by each respective ear unit 30b, 30c, back to the external signal receiver 20.

The processing means 22 of external receiver 20 processes the directionality signals 38_{DS1}, 38_{DS2} and original audio signal AS₁ by, for example, comparing the directionality signals 38_{DS1}, 38_{DS2} to the original audio signal AS₁, and determines the direction of origin of the audio signal AS₁. The processing means 22 also generates reconstructed acoustic signals RS₁, RS₂ for each ear associated with ear units 30b, 30c; each reconstructed acoustic signal RS₁, RS₂ comprising a spectrally optimized signal having discernible directionality characteristics, i.e. a first reconstructed acoustic signal having a first volume and/or phase (RS₁), and a second reconstructed acoustic signal having a second volume and/or phase (RS₂).

As illustrated in FIG. 2, the first and second reconstructed acoustic signals RS₁, RS₂ are then transmitted to ear unit 30b and 30c, respectively, by the external signal receiver 20 and, thereafter, to the inner ears of the subject via the ear units 30b, 30c.

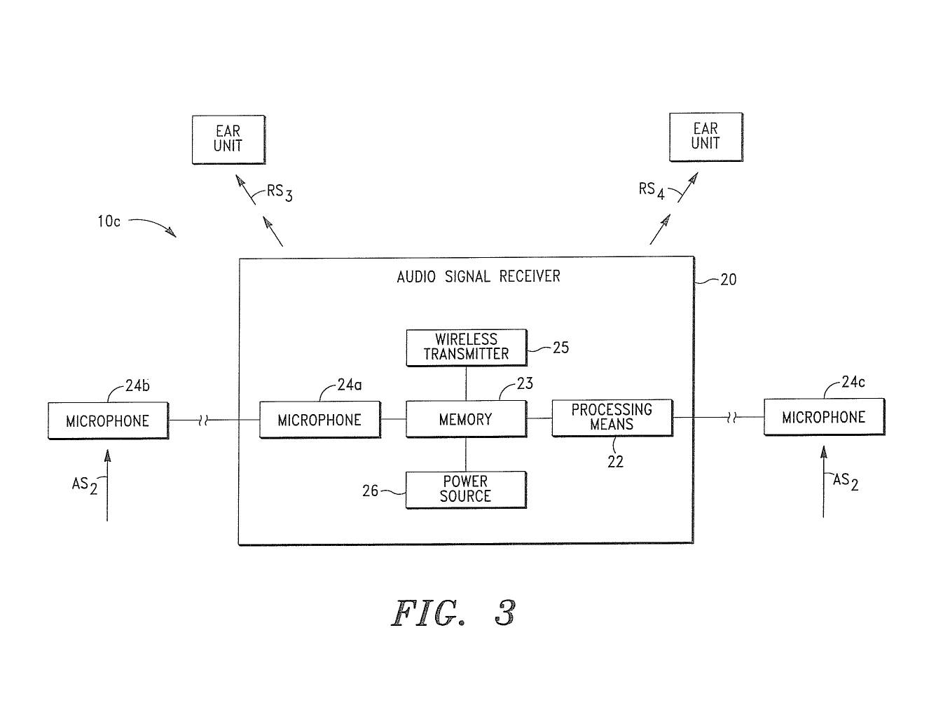

Referring now to FIG. 3, in some embodiments of the invention, the reconstructed acoustic signals (denoted “RS₃ and RS₄) include “presented” directionality parameters or components. As illustrated in FIG. 3, in the noted embodiments, the hearing aid system 10c similarly includes two (2) ear units 30a or, in some embodiments, ear units 30b, 30c.

As further illustrated in FIG. 3, the hearing aid system 10c further includes a microphone array, including additional microphones 24b, 24c, that are in communication with the audio signal receiver 20. According to the invention, the microphones 24b, 24c and 24a can similarly comprise directional microphones.

According to the invention, microphones 24b and 24c are configured to detect and receive an external audio signal AS₂ and transmit the signal AS₂, including the amplitude and phase thereof, to the audio signal receiver 20.

In a preferred embodiment, the processing means 22 is similarly programmed to process the input signals received by microphones 24b, 24c (and 24a) and generate reconstructed “tagged” acoustic signals therefrom; the reconstructed “tagged” acoustic signals including “presented” directionality parameters.

In some embodiments of the invention, the audio signal receiver 20 further includes a GPS unit or subsystem, wherein derived GPS signals can be employed to further tag the presented directional signal.

According to the invention, the microphones 24b, 24c can be disposed at various external positions. In some embodiments of the invention, microphones 24b, 24c are spaced and directed, whereby the spacing and directionality of the sound can be approximated.

A further significant feature and, hence, advantage of the hearing aid systems of the invention is that the systems provide directional hearing that is related to the direction of the user's head. As discussed in detail below, in some embodiments of the invention, the audio signal receiver 20 is further programmed to generate reconstructed acoustic signals by, among other things, correlating the direction of a user's head relative to the position of the audio signal receiver 20.

According to the invention, several methods can be employed to correlate the direction of the user's head relative to the position (or location) of the audio signal receiver 20. One method comprises analyzing the reconstructed acoustic signal(s) transmitted to an ear unit (e.g., ear unit 30a) by the audio signal receiver 20. In some embodiments, the reconstructed acoustic signal(s) are analyzed to determine the distance between the audio signal receiver 20 and an ear unit.

According to the invention, various known analysis methods for determining the travel distance of a signal can be employed to determine the distance between the audio signal receiver 20 and an ear unit. The known methods include, without limitation, signal strength analysis, time of flight, phase or group of phase analysis, etc.

By way of example, in one embodiment of the invention, when an audio signal receiver of the invention is disposed proximate a user's chest region, i.e. attached to clothing or disposed on a chain around the neck, distance analysis is performed using signal strength. When an ear unit (e.g. ear unit 30a), which is disposed in the right ear of a user, detects lower signal strength, it is determined to be farther from the front of the chest and the user's head is determined to be turned to the right or clockwise (looking down upon the user).

According to the invention, the variation in signal strength can then be employed to generate and transmit a reconstructed acoustic signal (intended for that particular direction of head orientation) to an ear unit and, hence, user.

In some embodiments of the invention, the directionality signals are generated by the audio signal receiver 20.

As stated, in some embodiments, the ear unit includes processing means, e.g. a microprocessor. In the noted embodiments, the ear unit processing means is also programmed and adapted to generate the directionality signals.

According to the invention, the directionality signals can also be modified by, for example, modifying the gain or phase or delay of the signal.

In some embodiments of the invention, the audio signal receiver 20 is further programmed to generate and transmit a distance signal that can be used to determine the distance from the audio signal receiver 20 to an ear unit (e.g. 30a).

According to the invention, the distance signal can comprise a distinct signal, e.g., timing, power, frequency, etc. The distance signal can also be sent periodically, i.e. steady state or randomly.

The noted methods can further include a calibration step. In some embodiments, the calibration step comprises having the user rotate their head to one or more orientations and at known degrees, e.g., 90°, to the right and left. Signal analysis can then be performed and calibrated for a specific placement of the audio signal receiver and for a specific user. The signal(s) can also be calibrated for different environments.

A further method of correlating the direction of a user's head relative to the position of an audio signal receiver 20 comprises correlating audio signals received directly by at least one, more preferably, two ear units, i.e. a slave disposed in a first ear and a master disposed in the other ear, with audio input signals received by the audio signal receiver.

According to the invention, the noted system can include the single microphone system 10a shown in FIG. 1 or the multiple microphone system 10c shown in FIG. 3.

According to the invention, various conventional methods can be employed to correlate the direction of a user's head relative to the position of an audio signal receiver 20 with a master and slave ear unit system.

According to the invention, the correlation analysis and amplification can also be performed by an ear unit processing means, e.g. microprocessor.

According to the invention, signals transmitted by the ear units can be transmitted in whole or in parts. If the signals are transmitted partially, the power required to transmit the signals can be greatly reduced.

### EXAMPLES

The following examples are provided to enable those skilled in the art to more clearly understand and practice the present invention. They should not be considered as limiting the scope of the invention, but merely as being illustrated as representative thereof.

### Example 1

A forty-five (45) year old male presents with a 30 db hearing loss in his left ear and a 10 db hearing loss in his right ear.

A hearing aid system of the invention, such as illustrated in FIG. 3, is provided to the male subject. The audio signal receiver and associated microphones are disposed on the subject's garment. The ear units, which are inserted into the subject's left and right ears, comprise ear units illustrated in FIG. 1.

The audio signal receiver and associated microphones detect a conversation between two people. The audio signals detected by the microphones are transmitted to the signal receiver, wherein the signals are processed; the processing including determining the direction of origin of the audio signals, i.e. left side of subject. First and second reconstructed acoustic signals are also generated by the signal receiver; the first and second reconstructed acoustic signals including directionality parameters. In this instance, the directionality parameters comprise presented signal amplitudes.

The second reconstructed acoustic signal, having a signal amplitude of approx 10 db, is transmitted to the subjects right ear and the first reconstructed acoustic signal, having an enhanced signal amplitude of approx 50 db, is transmitted to the subjects left ear, whereby the subject readily perceives that the direction of origin of the conversation is on his left side.

### Example 2

A thirty-three (33) year old male presents with a 20 db hearing loss in his left ear and a 10 db hearing loss in his right ear.

A hearing aid system of the invention, such as illustrated in FIG. 3, is similarly provided to the male subject. The audio signal receiver and associated microphones are disposed on the subject's garment. The ear units, which are inserted into the subject's left and right ears, comprise ear units illustrated in FIG. 1.

The audio signal receiver and associated microphones detect a third party calling the subject. The audio signals detected by the microphones are transmitted to the signal receiver, wherein the signals are processed; the processing including determining the direction of origin of the audio signals, i.e. right side of subject. First and second reconstructed acoustic signals are also generated by the signal receiver; the first and second reconstructed acoustic signals including directionality parameters. In this instance, the directionality parameters comprise the amplitude and phase of the signals.

The second reconstructed acoustic signal, having a signal amplitude of approx. 0 db and phase of approx. 0°, is transmitted to the subjects left ear and the first reconstructed acoustic signal, having a signal amplitude of approx 10 db and phase of approx. 180°, is transmitted to the subjects right ear, whereby the subject readily perceives that the direction of origin of the third party calling his name is on his right side.

As will readily be appreciated by one having ordinary skill in the art, the present invention provides numerous advantages compared to prior art hearing aids. Among the advantages are the following:

The provision of hearing aid systems that generate and transmit reconstructed acoustic signals from the external audio signals, which, when transmitted to a subject, allow him/her to perceive the direction of origin of the external audio signals and/or spatial orientation of components of the audio signals.

The provision of hearing aid systems having ear units with minimal power requirements.

The provision of hearing aid systems that eliminate the feedback problems that are associated with most hearing aids.

Another significant advantage of the hearing aid systems of the invention is that they can be readily employed to transmit various additional audio signals from a variety of sources to a user, including, without limitation, cell phone signals, Bluetooth signals, TV signals, GPS signals, radio signals, other microphone or speaker signals, etc.

According to the invention, the sources can comprise the audio signal receiver itself or the audio signal receiver can be adapted to communicate directly with the source, e.g. cell phone.

Without departing from the spirit and scope of this invention, one of ordinary skill can make various changes and modifications to the invention to adapt it to various usages and conditions. As such, these changes and modifications are properly, equitably, and intended to be, within the full range of equivalence of the claims.

What is claimed is:

1. A hearing aid system, comprising:
a first ear unit configured to be disposed proximate a first ear of a subject;
a second ear unit configured to be disposed proximate a second ear of a subject; and
an external audio signal receiver,
said first and second ear units including at least one audio sensor and a transceiver, said audio sensor being configured to detect and receive audio signals emanating from the environment, said transceiver being configured to transmit directionality signals to said acoustic signal receiver, said directionality signals representing amplitude and phase of detected audio signals, and receive reconstructed acoustic signals transmitted by said audio signal receiver,
said audio signal receiver including a power source, at least a first microphone configured to detect and receive said audio signals, and processing means for processing said audio and directionality signals, said processing means being programmed to generate at least first and second reconstructed acoustic signals from said audio and directionality signals, said first and second reconstructed acoustic signals including direction parameters representing a direction of origin of said audio signals,
said audio signal receiver further including wireless signal transmission means for transmitting said first and second reconstructed acoustic signals to said first and second ear units.

2. The hearing aid system of claim 1, wherein said first reconstructed acoustic signal has a first amplitude and a first phase and said second reconstructed acoustic signal has a second amplitude and a second phase.

3. The hearing aid system of claim 2, wherein said first and second reconstructed acoustic signals comprise spectrally optimized acoustic signals.

4. The hearing aid system of claim 1, wherein said first and second ear units include means for transmitting said first and second reconstructed acoustic signals to the ear canal of said first and second ear.

5. The hearing aid system of claim 1, wherein said first microphone comprises a directional microphone.

6. The hearing aid system of claim 1, wherein said audio signal receiver processing means is further programmed to correlate a direction of at least said subject's first ear relative to said audio signal receiver.

7. The hearing aid system of claim 6, wherein said audio signal receiver processing means is further programmed to differentiate a plurality of audio signals contained in a single medium.

8. The hearing aid system of claim 6, wherein said audio signal receiver processing means is further programmed to generate said first and second reconstructed acoustic signals with enhanced amplitude of at least one of said plurality of audio signals.

9. A hearing aid system, comprising:
a first ear unit configured to be disposed proximate a first ear of a subject;
a second ear unit configured to be disposed proximate a second ear of a subject; and
an external audio signal receiver,
said first and second ear units including a transceiver, said transceiver being configured to receive reconstructed acoustic signals transmitted by said audio signal receiver and transmit said reconstructed acoustic signals to an ear canal of said subject,
said audio signal receiver including a power source, at least a first microphone configured to detect and receive audio signals, and processing means for processing said audio signals, said processing means being programmed to generate at least first and second reconstructed acoustic signals from said audio signals, said first and second reconstructed acoustic signals including direction parameters representing a direction of origin of said audio signals,
said audio signal receiver further including wireless signal transmission means for transmitting said first and second reconstructed acoustic signals to said first and second ear units.

10. The hearing aid system of claim 9, wherein said system includes second and third microphones that are configured to detect and receive said audio signals, and transmit said received audio signal to said audio signal receiver.

11. The hearing aid system of claim 9, wherein said first reconstructed acoustic signal has a first amplitude and said second reconstructed acoustic signal has a second amplitude.

12. The hearing aid system of claim 9, wherein said first reconstructed acoustic signal has a first amplitude and a first phase and said second reconstructed acoustic signal has a second amplitude and a second phase.

13. The hearing aid system of claim 9, wherein said first and second reconstructed acoustic signals comprise spectrally optimized acoustic signals.

14. The hearing aid system of claim 9, wherein said audio signal receiver processing means is further programmed to correlate a direction of at least said subject's first ear relative to said audio signal receiver.

15. The hearing aid system of claim 9, wherein said audio signal receiver processing means is further programmed to differentiate a plurality of audio signals contained in a single medium.

16. The hearing aid system of claim 15, wherein said audio signal receiver processing means is further programmed to generate said first and second reconstructed acoustic signals with enhanced amplitude of at least one of said plurality of audio signals.
